(19) United States
(12) Patent Application Publication
(10) Pub. No.: US 2016/0359162 A1
(43) Pub. Date: Dec. 8, 2016

(54) COMPOSITION FOR PREPARING SILICON-CARBON COMPOSITE, SILICON-CARBON COMPOSITE, ELECTRODE FOR SECONDARY BATTERY COMPRISING SAME, AND METHOD FOR PRODUCING SILICON-CARBON COMPOSITE

(71) Applicant: OCI COMPANY LTD., Seoul (KR)

(72) Inventors: Yo-Seop KIM, Seongnam-si (KR); Sung-Ho JUNG, Seongnam-si (KR); Eun-Hye JEONG, Seongnam-si (KR); Jeong-Hyun HA, Seongnam-si (KR)

(21) Appl. No.: 15/176,113

(22) Filed: Jun. 7, 2016

(30) Foreign Application Priority Data
Jun. 8, 2015 (KR) 10-2015-0080837

(51) Int. Cl. H01M 4/134; H01M 4/583; H01M 4/133; H01M 4/62; H01M 4/04; H01M 10/0525

(52) U.S. Cl. CPC H01M 4/134; H01M 4/0471; H01M 4/043; H01M 10/0525; H01M 4/133; H01M 4/622; H01M 4/583; H01M 4/624; H01M 2004/027

(57) ABSTRACT

The present disclosure relates to a composition for preparing a silicon-carbon composite having nano-Si particulates and electrically conductive materials dispersed in an amorphous carbon, the silicon-carbon composite prepared therefrom, an electrode for secondary battery comprising the silicon-carbon composite, and a method for producing the silicon-carbon composite.

### BACKGROUND

1. Technical Field

The present disclosure relates to a composition for preparing a silicon-carbon composite having nano-Si particulates and electrically conductive materials dispersed in an amorphous carbon, a silicon-carbon composite prepared therefrom, an electrode for secondary battery comprising the silicon-carbon composite, and a method for producing the silicon-carbon composite.

2. Description of the Related Art

Lithium secondary batteries are widely used as a power source for various devices due to high energy density, high voltage and high capacity properties compared to other secondary batteries.

In particular, a negative electrode active material for lithium secondary battery and a negative electrode material containing the same which both can achieve a high capacity are required for use in IT devices and vehicle battery applications.

In general, carbonaceous materials such as graphite are mainly used as a negative electrode active material for a lithium secondary battery. The theoretical capacity of graphite is about 372 mAh/g, and given the loss of capacity, the actual discharge capacity is merely about 310 to 330 mAh/g. Thus, there are increasing demands for a lithium secondary battery having higher energy density.

In order to meet these requirements, researches have been made on a metal or an alloy for use as a negative electrode active material for a high-capacity lithium secondary battery, and in particular, among those, attentions have been paid to silicon.

For example, pure silicon is known to have a high theoretical capacity of 4,200 mAh/g.

However, since silicon material is lower in cycle characteristics as compared to a carbonaceous material, it so far becomes an obstacle in practical use.

The reason is that when inorganic particles such as silicon for a negative electrode active material is used as a lithium occlusion and release material per se, the conductivity between the active materials is adversely affected due to volume changes during the course of charge and discharge procedures, or negative electrode active materials are detached from a negative electrode current collector.

In other words, inorganic particles such as silicon contained in a negative electrode active material occlude lithium during charge, and so expanded to about 300 to 400% in volume, while when the lithium is released during discharge, the inorganic particles will shrink again.

With such charge and discharge cycles repeated, void space may occur between the inorganic particles and the negative electrode active material, leading to an electrical insulation, and in turn rapidly decreasing a life span, which therefore causes a serious problem for use in secondary batteries.

Further, when the silicon is not sufficiently dispersed in the negative electrode active material or present only on a surface of the negative electrode active material, the problem due to the above-mentioned volume changes may act more seriously.

Therefore, there is a need for development of novel candidate materials for a negative electrode active material having a sufficient battery capacity and good cycle characteristics, while inhibiting a separation of silicon by uniformly dispersing the silicon in the negative electrode active material and reducing the volume changes in the silicon.

### SUMMARY

It is an aspect of the present disclosure to provide a negative active material for improving charge capacity and life characteristics in a secondary battery by inhibiting a separation of silicon from the active material by uniformly dispersing Si in a silicon-carbon composite while at the same time buffering volume changes in the silicon.

Accordingly, the present disclosure aims to provide a composition for preparing a silicon-carbon composite having nano-Si particulates and electrically conductive materials dispersed in an amorphous carbon, the silicon-carbon composite prepared therefrom, a negative electrode for secondary battery comprising the silicon-carbon composite, and a method for producing the silicon-carbon composite.

In order to achieve the above mentioned aims, the present disclosure provides a composition for preparing a silicon-carbon composite, wherein a combined material having nano-Si particulates and electrically conductive materials uniformly dispersed in a polymer matrix is embedded in an amorphous carbon, whereby capable of maintaining the dispersibility of the nano-Si particulates and the electrically conductive materials in a liquid phase.

Further, the present disclosure provides a silicon-carbon composite having the nano-Si particulates and the electrically conductive materials dispersed in the amorphous carbon, wherein, in a cross-section of the composite taken by a scanning electron microscope, when the cross-section of the composite is divided into nine regions having an equal area respectively, the content (% by weight) of the nano-Si particulates within each region is 0.3 to 1.7 times higher than the average value of the content (% by weight) of the nano-Si particulates over the entire region.

In addition, the present disclosure provides an electrode for a secondary battery comprising the silicon-carbon composite and a carbon support.

Further, the present disclosure provides a method for producing a silicon-carbon composite, comprising: (1) forming a slurry of nano-Si particulates; (2) mixing the slurry of nano-Si particulates and an electrically conductive material; (3) heating and then grinding the mixture in step (2) to form a combined mixture of the nano-Si particulates/electrically conductive material; (4) dissolving an amorphous carbon in a solvent to form a carbonaceous solution; and (5) adding the combined mixture of the nano-Si particulates/electrically conductive material in step (3) to the carbonaceous solution in step (4) and then subjecting to a carbonization and pulverization.

As described above, the silicon-carbon composite having the nano-Si particulates and the electrically conductive materials dispersed in an amorphous carbon is embedded into a secondary battery, whereby the charge-discharge capacity and the life characteristics of the battery can be improved.

In the silicon-carbon composite of the present disclosure, the nano-Si particulates and the electrically conductive materials are uniformly dispersed in the amorphous carbon, such that the electrical conductivity within the electrode can be improved and the silicon content in the composite can be also increased.

Additionally, when the electrode for a secondary battery comprising the silicon-carbon composite and the carbon support is used as a negative electrode for a lithium secondary battery, the charge capacity and life characteristics and the compatibility with the conventional negative electrode material can be further improved.

### BRIEF DESCRIPTION OF DRAWINGS

FIG. 1 schematically shows a cross-section of an embodiment where a combined material having nano-Si particulates and electrically conductive materials contained in a three-dimensional network structure of a polymer matrix is dispersed in an amorphous carbon.

FIG. 2A and FIG. 2B show the results obtained by determining the content (% by weight) of the nano-Si particulates on a SEM cross-section of the silicon-carbon composite according to an embodiment of the present disclosure with an energy dispersive X-ray (EDX) analyzer.

FIG. 3 shows a schematic cross-sectional view of an electrode for a secondary battery according to an embodiment of the present disclosure.

FIG. 4 shows the measurement results for the capacity (specific capacity) of a secondary battery prepared according the working examples and the comparative examples.

### DETAILED DESCRIPTION

Advantages and features of the present disclosure, and methods for accomplishing them will become more apparent from the following embodiments taken in conjunction with the accompanying drawings. However, the present disclosure is not limited to the disclosed embodiments, but may be implemented in various manners. The embodiments are provided to complete the disclosure of the present invention and to allow those having ordinary skill in the art to understand the scope of the present invention. The present invention is defined by the category of the claims. The same reference numbers will be used throughout the drawings to refer to the same or like parts.

Hereinafter, the present invention will be described in detail.

The present disclosure provides a composition for preparing a silicon-carbon composite having a combined mixture comprising a polymer matrix, nano-Si particulates dispersed in the polymer matrix, and an electrically conductive material is embedded.

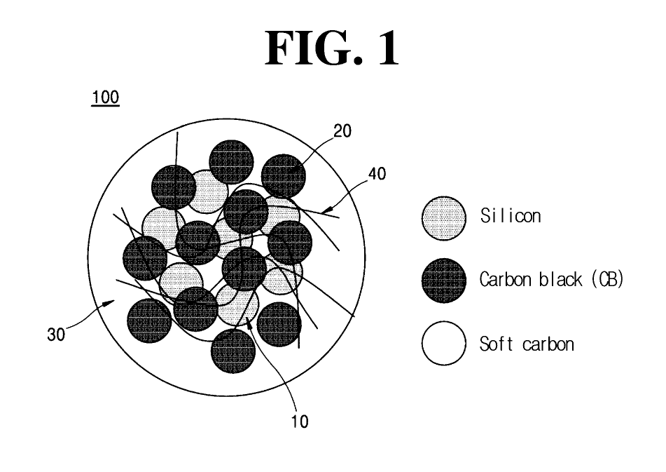

FIG. 1 schematically shows a cross-section of a precursor of silicon-carbon composite 100 where a combined mixture comprising nano-Si particulates 10 and electrically conductive materials 20 contained in the polymer matrix 40 is dispersed in an amorphous carbon 30.

The combined mixture may be of a form such that the nano-Si particulates and the electrically conductive materials are uniformly dispersed in a polymer matrix forming a three-dimensional network structure, whereby due to such network structure, the nano-Si particulates and the electrically conductive materials can be contained in the polymer matrix without a separation of a layer.

This can provide an improved dispersibility of the particles compared to a combined mixture where the nano-Si particulates are randomly dispersed in a solvent, and can also achieve a buffering effect on the volume changes of Si which may occur during repetition of a charge/discharge cycle.

Further, when the nano-Si particulates are randomly dispersed in a solvent, during mixing of the nano-Si particulates and a dissolved amorphous carbon, the dispersibility of the nano-Si particulates may be deteriorated.

On the contrary, the composition for preparing a silicon-carbon composite according to the present disclosure is made by fixing the dispersibility of the nano-Si particulates dispersed in a solvent with the polymer matrix comprising a three-dimensional network structure, and then mixing with an amorphous carbon, thereby capable of effectively maintaining the dispersibility of the initial nano-Si particulates.

As used herein, the term “three-dimensional network structure” refers to a structure that is designed as a micro-model of an amorphous polymer material with a cross-linking point, and comprises knots and chains connecting them.

At this time, the nano-Si particulates are dispersed in such network structure of the polymer matrix, and due to such three-dimensional network structure of the polymer matrix, the nano-Si particulates and the electrically conductive materials may be included with a very uniform dispersion within the combined mixture.

In this embodiment, the polymer matrix may be cross-linked to form a gel type polymer matrix.

In addition, the polymer matrix having such three-dimensional network structure, when repeating the charge and discharge cycles of the battery, is suitable as a material for buffering effect on the volume changes in the nano-Si particulates, and can ultimately improve the life characteristics of the battery.

Specifically, the polymer matrix may include a cross-linkable monomer having a high affinity to the nano-Si particulates to enhance the dispersibility thereof.

For example, the polymer matrix may be a copolymer of at least one cross-linkable monomer selected from acrylic acid, acrylate, methyl methacrylic acid, methyl methacrylate, acrylamide, vinyl acetate, maleic acid, styrene, acrylonitrile, phenol, ethylene glycol, lauryl methacrylate, and vinyl difluoride.

The cross-linkable monomer may be a starting material for forming a polymer. In this regard, when lithium is occluded in Si during charge, thereby allowing volume expansion, and lithium is released during discharge, thereby allowing volume reduction, the polymer matrix prepared from the cross-linkable monomer may act as a buffer.

Additionally, in addition to the cross-linkable monomer, a cross-linking agent may be included to form the polymer matrix.

The cross-linking agent serves to cross-link the copolymers formed from the cross-linkable monomers with each other, thereby making the polymer matrix to have a three-dimensional network structure.

The cross-linking agent that may be used for cross-linking the cross-linkable monomers utilized in the present disclosure may include ethylene glycol dimethacrylate, ethylene glycol diacrylate, diethylene glycol dimethacrylate, diethylene glycol diacrylate, triethylene glycol diacrylate, tetraethylene glycol diacrylate, N,N-methylenebisacrylamide, N,N-(1,2-dihydroxyethylene)bisacrylamide, or divinylbenzene.

In addition, additives such as a radical polymerization initiator may be used to form the polymer matrix, and the radical polymerization initiator may include, but is not limited to, 1,1′-azobis (cyclohexanecarbonitrile) (ABCN), azobisisobutyronitrile (AIBN), benzophenone, 2,2-dimethoxy-2-phenyl acetophenone, or benzoyl peroxide.

The composition for producing a silicon-carbon composite of the present disclosure may include nano-sized Si particulates, wherein the nano-sized Si particulates may first be used to prepare a Si slurry solution separately prior to be mixed with the electrically conductive materials within the polymer matrix.

The Si slurry solution may be used as a slurry state in which the silicon particles uniformly dispersed therein are distributed in a dispersion medium, thereby achieving a composition for preparing a silicon-carbon composite where the nano-Si particulates are uniformly distributed throughout the whole combined mixture, as well as, unlike a silicon powder exposed to air, the silicon particles are not exposed to air, and therefore the oxidation of Si can be inhibited.

The inhibition of the oxidation of Si may lead to a further enhanced capacity when applied to a secondary battery, and thereby the electrical characteristics of the secondary battery can be further improved.

The dispersion medium is a solvent for further improving the dispersibility and stability of the Si slurry, and may include, but is not limited to, at least one selected from the group consisting of N-methyl-2-pyrrolidone (NMP), tetrahydrofuran (THF), water, methanol, ethanol, cyclohexanol, cyclohexanone, methyl ethyl ketone, acetone, and dimethyl sulfoxide (DMSO).

In this case, when N-methyl-2-pyrrolidone (NMP) solvent or tetrahydrofuran (THF) solvent is used, the nano-Si particulates can be more uniformly dispersed, with maintaining stable dispersion state in the solvent.

Si slurry has a small D50 with uniform distribution having a narrow size deviation between the particles. The silicon-carbon composite in which a combined mixture produced from a solution of the silicon slurry comprising evenly well dispersed nano-sized silicon particles is embedded in an amorphous carbon is applied to an electrode for secondary battery, the volume expansion problems in Si according to the occlusion and releasing of the nano-Si particulates during charge and discharge can be alleviated, thereby suppressing the occurrence of the electrical insulation in the electrode, and improving the life characteristics of the secondary battery.

Specifically, the nano-Si particulates, as indicated by D50 which is defined as a diameter corresponding to 50% cumulative weight in particle size distribution, may have a particle size distribution characteristic of 2 nm<D50<120 nm, and the nano-Si particulates, as indicated by D90 which is defined as a diameter corresponding to 90% cumulative weight in particle size distribution, may have a particle size distribution characteristic of 1<D90/D50<1.4.

In this embodiment, the distribution characteristic enables the nano-Si particulates to be uniformly dispersed in the polymer matrix, as described above, and thus aggregation phenomena between the nano-Si particulates is significantly avoided. Consequently, the combined mixture can be more sufficiently dispersed in the amorphous carbon.

In this way, the nano-Si particulates in the slurry for producing silicon-carbon composite has a small D50 with a uniform distribution having a narrow size deviation between the particles, and eventually the distribution of the nano-Si particulates becomes uniform in the secondary battery.

In addition, the electrically conductive material may be at least one selected from the group consisting of carbon black, ketjen black, lamp black, channel black, acetylene black, furnace black, thermal black, graphene, fullerene, carbon nanotube, and carbon nanofiber.

The electrically conductive material is uniformly dispersed within the polymer matrix together with the nano-Si particulates, and thereby the silicon-carbon composite formed in such a way that a combined mixture produced therefrom is dispersed in the amorphous carbon allows it to secure higher electrical conductivity.

Further, the electrical conductivity can be maintained over a certain level even when Si is expanded during an electrochemical reaction at an electrode, and the electrical resistance of the electrode can be maintained much lower.

In addition, as the content of the electrically conductive materials in the silicon-carbon composite compared to the nano-Si particulates increases up to a certain level, Si capacity expression rate can be increased to thereby increase the discharge capacity.

The composition for producing a silicon-carbon composite according to an embodiment of the present disclosure may include 10 to 40 parts by weight of nano-Si particulates, 10 to 40 parts by weight of electrically conductive material, and 20 to 80 parts by weight of amorphous carbon, relative to 100 parts by weight of the composition.

The silicon-carbon composite produced from a composition comprising the nano-Si particulates, the electrically conductive materials, and the amorphous carbon within the above-mentioned ranges can effectively exhibit a high capacity silicon characteristics upon application as an electrode for a secondary battery, while mitigating the volume expansion problem during charge and discharge, whereby improving the life characteristics of the secondary battery.

For example, when the nano-Si particulates are contained in an amount of less than 10 parts by weight with respect to 100 parts by weight of the composition, the capacity of the battery itself becomes too small, while when contained in an amount of greater than 40 parts by weight, a region where Si particulates are agglomerated may be generated, thereby decreasing the dispersibility which eventually resulting in reduced battery life.

Further, when, with respect to 100 parts by weight of the composition, the electrically conductive material is contained in an amount of less than 10 parts by weight, the electrical conductivity cannot be maintained irrespective of the Si volume change, while when contained in an amount of greater than 40 parts by weight, the dispersibility may be decreased and the electrical resistance of the electrode may be increased.

The amorphous carbon may be at least one selected from a soft carbon and a hard carbon.

The combined mixture may be carbonized by dissolving the amorphous carbon into a solvent, wherein the amorphous carbon does not substantially include other impurities and by-product compounds, but consists only of carbon, and therefore the carbonization yield is significantly excellent.

According to another aspect of the present disclosure, there can be provided a silicon-carbon composite where the nano-Si particulates and the electrically conductive materials are dispersed in the amorphous carbon.

When silicon is contained as a conventional negative electrode active material to implement high capacity of battery, problems may occur that the electrical conductivity is decreased due to the volume changes in Si during the battery charge and discharge process, and the negative electrode active material is detached from the negative electrode current collector. In addition, the above-mentioned problems were more pronounced if the silicon is not uniformly dispersed in the negative electrode active material.

Accordingly, the silicon-carbon composite provided by the present disclosure is characterized in that the nano-Si particulates are uniformly dispersed in the amorphous carbon as observed from a cross-sectional view of the composite taken by a scanning electron microscope.

The high dispersibility of the nano-Si particulates in the composite can be achieved by allowing the nano-Si particulates present in a uniformly dispersed state in a solvent to be captured by the polymer matrix having a three-dimensional network structure to thereby form a combined mixture, and maintain the dispersibility of the nano-Si particulates in the combined mixture also within the amorphous carbonaceous material.

In particular, the cross-section of the composite according to an embodiment of the present disclosure is divided into nine regions having an equal area respectively, the content (% by weight) of the nano-Si particulates within each region is 0.3 to 1.7 times the average value of the content (% by weight) of the nano-Si particulates over the entire region.

At this time, if the content is out of the above described ranges, the nano-Si particulates in the composite would not be uniformly dispersed.

For example, the nano-Si particulates may be excessively concentrated or deficient in at least some region of the composite.

If the nano-Si particulates are not uniformly distributed over the entire region, the Si particulates are sensitive to the volume changes in the Si during the battery charge-discharge procedure and thereby the conductivity would be reduced, and the silicon would be more likely to be peeled off from the composite.

Thus, when the content (% by weight) of the nano-Si particulates within each region relative to the average value of the content (% by weight) of the nano-Si particulates over the entire region is present within the above described range, aggregation phenomena between the nano-Si particulates in their excessively concentrated region can be inhibited, and the likelihood of damage to a negative electrode active material due to the volume changes in silicon can be reduced.

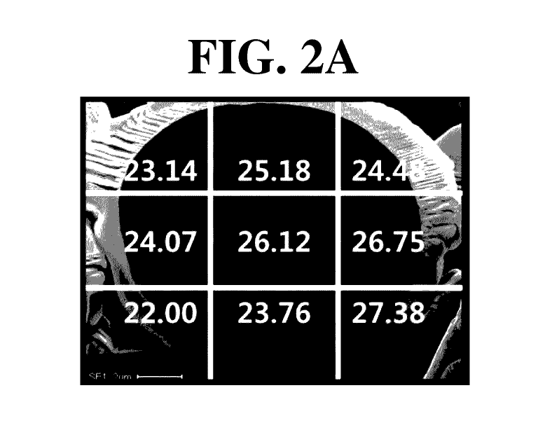

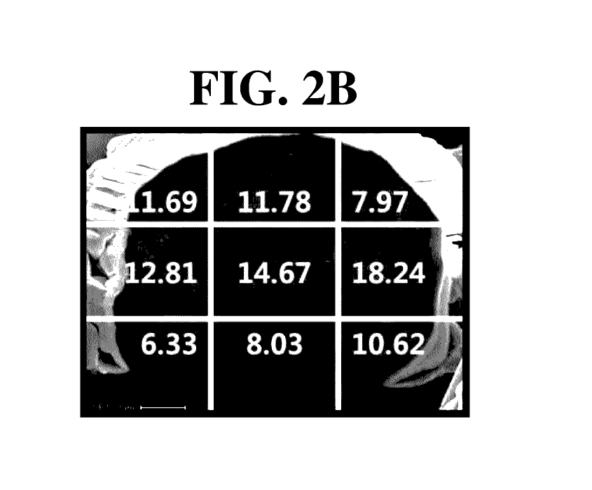

Referring to FIG. 2A and FIG. 2B, the results obtained by determining the content (% by weight) of the nano-Si particulates in SEM cross-section of the silicon-carbon composite according to an embodiment of the present disclosure with an energy dispersive X-ray (EDX) analyzer are shown.

Specifically, FIG. 2A shows a silicon-carbon composite produced from a composition comprising 25% by weight of nano-Si particulates relative to the total weight of the composition, and FIG. 2B shows a silicon-carbon composite produced from a composition comprising 15% by weight of nano-Si particulates relative to the total weight of the composition.

For the silicon-carbon composite according to FIG. 2A, it can be seen that the average value of the content (% by weight) of the nano-Si particulates over the entire region is 24.76% by weight, and the content (% by weight) of the nano-Si particulates within each region is in the range of 0.3 to 1.7 times the average value of the content (% by weight) of the nano-Si particulates over the entire region.

In addition, for the silicon-carbon composite according to FIG. 2B, it can be seen that the average value of the content (% by weight) of the nano-Si particulates over the entire region is 11.35% by weight, and the content (% by weight) of the nano-Si particulates within each region is in the range of 0.3 to 1.7 times the average value of the content (% by weight) of the nano-Si particulates over the entire region.

That is, in the silicon-carbon composite according to an embodiment of the present disclosure, the nano-Si particulates and the electrically conductive materials randomly distributed in solution are allowed to maintain the dispersibility in the amorphous carbon using the polymer matrix, whereby the nano-Si particulates will not be biased to one side, but can provide a silicon-carbon composite uniformly entrapped within the amorphous carbon.

The silicon-carbon composite having the above-mentioned characteristics can effectively exhibit high capacity silicon properties upon application as a negative electrode active material for a lithium secondary battery, while mitigating the volume expansion problem during charge and discharge, whereby improving the life characteristics of the secondary battery.

The silicon-carbon composite in which the nano-Si particulates are more evenly well-dispersed can implement a better capacity than that of comprising the same content of nano-Si particulates. For example, the composite can achieve at least about 80% of the theoretical capacity of silicon.

In certain embodiments, the silicon-carbon composite may include nano-sized Si particulates, wherein the nano-sized Si particulates may first be used to prepare a Si slurry solution separately prior to be mixed with the electrically conductive materials.

The electrically conductive material may be at least one selected from the group consisting of carbon black, Ketjen black, lamp black, channel black, acetylene black, furnace black, thermal black, graphene, fullerene, carbon nanotube, and carbon nanofiber. As described above, the conductive material is uniformly dispersed in a polymer matrix together with the nano-Si particulates, such that the silicon-carbon composite is able to ensure the electrical conductivity. Further, the electrical conductivity can be maintained over a certain level even when Si is expanded during an electrochemical reaction at an electrode, and the electrical resistance of the electrode can be maintained much lower.

In addition, as the content of the electrically conductive materials in the silicon-carbon composite compared to the nano-Si particulates increases up to a certain level, Si capacity expression rate can be increased, which in turn increases the discharge capacity.

In certain embodiments, the silicon-carbon composite may include 10 to 40 parts by weight of the nano-Si particulates, 10 to 40 parts by weight of the electrically conductive material, and 20 to 80 parts by weight of the amorphous carbon.

The silicon-carbon composite produced from a composition comprising the nano-Si particulates, the electrically conductive materials, and the amorphous carbon within the above-mentioned ranges can effectively exhibit a high capacity silicon characteristics upon application as an electrode for a secondary battery, while mitigating the volume expansion problem during charge and discharge, such that the life characteristics of the secondary battery can be improved.

The amorphous carbon may be at least one selected from a soft carbon and a hard carbon.

The combined mixture can evenly be distributed over the amorphous carbon in the process of preparing a silicon-carbon composite, and, particularly, distributed over the entire region including a surface and inner part thereof within the amorphous carbon.

In accordance with another aspect of the disclosure, an electrode for a secondary battery comprising the above-mentioned silicon-carbon composite and a carbon support can be provided.

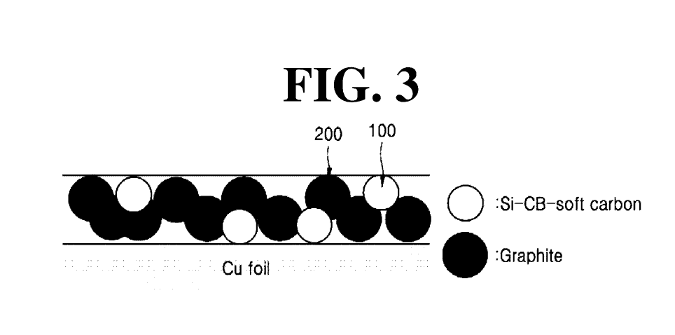

FIG. 3 schematically shows a cross-sectional view of the above-mentioned electrode for a secondary battery.

The silicon-carbon composite 100 is included in the electrode with a carbon support 200, such that it can prevent a decrease in the electrical conductivity and can suppress an increase in the electrode resistance, while at the same time improve the charge and discharge efficiency of the battery and also increase the charge and discharge cycle life.

In addition, due to a buffering action of the carbon support, the battery life can be improved to a natural graphite level.

The silicon-carbon composite may be pulverized through a process such as a jet mill or a planetary mill, whereby the composite may be present in spherical or particulate close to a sphere in shape.

The carbon support may be at least one selected from natural graphite, artificial graphite, soft carbon, hard carbon, pitch carbide, calcined coke, graphene, and carbon nanotubes.

More preferably, the carbon support may be spherical or particulate close to a sphere, or columnar in shape, and most preferred is spherical graphite.

In addition, the carbon support may be graphite having a shape of plate-like or a fragment. In this case, the carbon support may be spherically shaped with the silicon-carbon composite formed in a spherical shape, such that the spherical silicon-carbon composite can be captured between the layered carbon supports and spherically shaped in a dispersed phase.

In addition, considering an appropriate level of stability and capacity and service life, the weight ratio of the silicon-carbon composite and the carbon support powder can be adjusted within the range of 1:1 to 1:99.

In accordance with another aspect of the disclosure, a method for producing a silicon-carbon composite is provided.

The above-described method includes the following steps:

(1) forming a slurry of nano-Si particulates;

(2) mixing the slurry of nano-Si particulates and an electrically conductive material;

(3) heating and then grinding the mixture in step (2) to form a combined mixture of the nano-Si particulates/electrically conductive material;

(4) dissolving an amorphous carbon in a solvent to form a carbonaceous solution; and

(5) adding the combined mixture of the nano-Si particulates/electrically conductive material in step (3) to the carbonaceous solution in step (4) and then subjecting to a carbonization and pulverization.

Here, step (1) includes dispersing nano-sized Si particulates in a particular solvent to form slurry, wherein the nano-Si particulates may be spherical with a diameter of 2 nm to 200 nm, and the solvent is the same as the dispersion medium used in the composition for preparing a silicon-carbon composite mentioned above.

At this time, when N-methyl-2-pyrrolidone (NMP) solvent or tetrahydrofuran (THF) solvent is used as a dispersion medium, more excellent dispersibility and stability can be obtained.

Si slurry has a small D50 with uniform distribution having a narrow size deviation between the particles. Thus, the silicon-carbon composite where a combined mixture produced from a solution of the silicon slurry comprising evenly well dispersed nano-sized silicon particles is embedded in an amorphous carbon is applied to an electrode for a secondary battery, the volume expansion problems during charge and discharge can be alleviated, thereby improving the life characteristics of the secondary battery.

Specifically, the nano-Si particulates, as indicated by D50 which is defined as a diameter corresponding to 50% cumulative weight in particle size distribution, may have a particle size distribution characteristic of 2 nm<D50<120 nm, and the nano-Si particulates, as indicated by D90 which is defined as a diameter corresponding to 90% cumulative weight in particle size distribution, may have a particle size distribution characteristic of 1<D90/D50<1.4.

At this time, since the nano-Si particulates can be uniformly dispersed in the polymer matrix, as described above, aggregation phenomena between the nano-Si particulates is significantly reduced.

In this way, the nano-Si particulates in the slurry for producing a silicon-carbon composite has a small D50 with a uniform distribution having a narrow size deviation between the particles, so that the combined mixture can be more uniformly distributed in the amorphous carbon.

Further, in order to improve the dispersibility, additives for improving the dispersion may be added to the slurry solution, or a method for ultrasonic treatment of the slurry solution may be employed. In addition to the method illustrated above to enhance the dispersion, a variety of methods known in the art may be applied alone or in combination.

Step (2) may include mixing the nano-Si particulates and an electrically conductive material to form a mixture, wherein the electrically conductive material is the same as described above.

Specifically, the mixture may be prepared by introducing the electrically conductive material directly into the slurry of the nano-Si particulates, and stirring at a temperature of about 50 to 70° C. for 30 minutes to 60 minutes.

Carbon black is most preferred as the electrically conductive material. The use of carbon black can provide more improved conductivity of the electrode for the secondary battery and can achieve a high charge-discharge capacity.

Step (3) may include preparing a combined mixture of the nano-Si particulates and the electrically conductive material, which comprises heating the mixture of step (2) to remove the solvent, followed by grinding.

The heating may be carried out at a temperature of about 60 to 80° C. for about 10 to 12 hours, and the grinding may be conducted by a jet mill or a planetary mill to form a spherical combined mixture.

In this embodiment, since the electrically conductive material and the carbon black are uniformly dispersed in the combined mixture, the cycle characteristics of the secondary battery including the same have more than equal levels compared to the conventional carbon-based material, and the buffering action against Si volume changes and the electrical conductivity can be achieved more than a certain level.

Step (4) may include dissolving an amorphous carbon in a solvent to form a carbonaceous solution, wherein the carbonaceous solution is prepared for carbonization process.

As used herein, the carbonization process refers to a process where carbon raw materials are subjected to calcination at a high temperature to allow a residual carbon to remain as an inorganic material, and by way of such carbonization process, a carbonaceous solution forms a carbon matrix.

The combined mixture of the nano-Si particulates/electrically conductive material can be evenly dispersed in a carbonaceous solution consisting of the amorphous carbon.

Thus, when the carbon matrix is formed, the combined mixture and the carbon matrix are not aggregated, but a silicon-carbon composite where the combined mixture is evenly well dispersed in the carbon matrix can be realized.

The amorphous carbon may be for example a soft carbon or a hard carbon.

Step (5) may include adding the combined mixture of the nano-Si particulates/electrically conductive material in step (3) to the carbonaceous solution in step (4) and then subjecting to a carbonization and pulverization, i.e., the step of carbonizing of the combined mixture.

The carbonization process may be carried out at a temperature of 700° C. to 1400° C. for 0.5 hour to 5 hours.

Specifically, the carbonization process may be carried out at a low or high pressure condition of 0.5 bar to 10 bar, as required, and the heat treatment process may be performed in a single step or in multiple steps, as necessary.

Through this, the combined mixture may further comprise an amorphous carbon coating layer as an outermost layer.

Additionally, step (2) may further comprise adding a cross-linkable monomer, followed by subjecting to a polymerization.

Specifically, cross-linkable monomer, crosslinking agent and additives may be further mixed with the mixture of step (2), followed by heating and grinding in step (3), to form a combined mixture of the nano-Si particulates/electrically conductive material/polymer.

With the cross-linkable monomers and the cross-linking agent, polymer matrix having a three-dimensional network structure can be formed, whereby the nano-Si particulates and the electrically conductive materials can be highly uniformly dispersed in the polymer matrix.

At this time, the polymer matrix may be formed as a gel type polymer matrix due to the cross-linking caused by the cross-linking agent.

In addition, the polymer matrix having such three-dimensional network structure is suitable as a material for buffering of Si.

Hereinafter, preferred Examples of the present disclosure will now be described to provide a further understanding of the present disclosure. However, it should be noted that while the preferred examples are listed for easy understanding of the contents of the present disclosure, the present disclosure is not limited to these examples.

### Example 1

### Preparation of Nano-Si Particulates Slurry

Into a 27 g of tetrahydrofuran, polystyrene-co-polyacrylic acid was added and dissolved, and then 3 g of Si nanoparticles was added and dispersed through a continuous circulation process with ultrasonic treatment to form nano-Si particulates slurry.

At this time, with a dynamic light scattering method (instrument: ELS-Z2, Otsuka Electronics Co., Ltd.), the measurement results for Si distribution characteristic of the Si slurry indicated D50=120 nm.

Preparation of Combined Mixture

To 30 g of the nano-Si particulates slurry solution, 3 g of carbon black was added and vortex stirred, and then acrylic acid 2 g, polyethylene glycol methacrylate 2 g, 1,1′-azobis(cyclohexane carbonitrile) 0.5 g were added and stirred at a temperature of about 70° C. for about 12 hours. After stirring, the resulting mixture was dried to remove the solvent, and milled with a jet mill to form a combined mixture having Si particulates and carbon black uniformly dispersed in the polymer matrix.

Preparation of Silicon-Carbon Composite

Into 500 ml tetrahydrofuran, 6.7 g of amorphous carbon pitch powder was dissolved and stirred for more than 30 minutes to form a carbonaceous solution. To the carbonaceous solution, 7 g of the combined mixture was added and stirred over 12 hours to form a composition for preparing the silicon-carbon composite.

Then, the composition was subjected to a heat treatment at 1100° C. for at least one hour to remove the solvent to form a silicon-carbon composite containing a carbon matrix formed therein and containing 20% by weight of nano-Si particulates.

Manufacture of an Electrode for Secondary Battery

The silicon-carbon composite was milled in powder form with a jet mill, and 1:1 weight ratio of the composite powder and a carbon support was formulated to form a mixture.

Then, the mixture, carbon black, carboxymethyl cellulose (CMC), and styrene butadiene (SBR) were mixed in a weight ratio of 91:5:2:2. The mixture was coated on a copper current collector, and dried and rolled in an oven at 110° C. for about one hour to form an electrode for a secondary battery.

Manufacture of a Secondary Battery

The formed electrode for secondary battery, a separator, an electrolyte (as a mixed solvent of ethylene carbonate: diethyl carbonate (1:1 by weight), 1.0 M LiPF₆ added), and a lithium electrode were laminated in this order to form a secondary battery in the form of a coin cell.

### Example 2

The electrode for secondary battery and the secondary battery were prepared in the same manner as in Example 1, except that a spherical graphite was added as a carbon support to a powder consisting of the silicon-carbon composite formed in Example 1 during the manufacture of the electrode for secondary battery, and 1:3 weight ratio of the composite powder and the spherical graphite was added to the electrode.

### Example 3

The electrode for secondary battery and the secondary battery were prepared in the same manner as in Example 1, except no carbon support the carbon support during the manufacture of the electrode for secondary battery.

### Comparative Example 1

### Preparation of Silicon-Carbon Composite

To a solution of the nano-Si particulates slurry in Example 1, 5 g of acrylic acid, 1 g of ethylene glycol dimethacrylate, and 0.5 g of 1,1′-azobis(cyclohexane carbonitrile) were added, and then stirred at a temperature of 70° C. for 12 hours to prepare a Si-polymer matrix slurry. The Si-polymer matrix slurry was heat treated at a temperature of 400° C. for one hour in an electric furnace to prepare a Si-polymer carbide matrix. It was milled with a planetary mill to prepare Si-polymer carbide matrix particles.

To the Si-polymer carbide matrix particles, coal pitch was added in particulate form and mixed for 12 hours. The coal pitch and Si-polymer matrix particles were mixed in a weight ratio of 97.5:2.5. Then, the temperature was raised to 10° C./min and carbonization was performed at a temperature of 900° C. for 5 hours. Then, the mixture was milled with a jet mill to form a silicon-carbon composite.

The electrode for secondary battery and the secondary battery were prepared in the same manner as in Example 1, except for the process of producing the composite.

### Comparative Example 2

The electrode for secondary battery and the secondary battery were prepared in the same manner as in Example 1, except that the silicon-carbon composite was not included, but only the graphite was used, during the manufacture of the electrode for secondary battery.

### Experimental Example 1

### Changes in Initial Discharge Capacity, Initial Efficiency, and Charge Capacity Retention Rate According to the Presence or Absence of the Carbon Support Included in the Electrode

Charge and discharge was tested in the following conditions with respect to the secondary batteries manufactured in the Examples and the Comparative Examples.

Assuming that 400 mA per 1 g weight is 1 C, the charge condition was controlled at a constant current of 0.2 C up to 0.01 V, and controlled at a constant voltage of 0.01 V up to 0.01 C, while the discharge condition was controlled at a constant current of 0.2 C up to 1.5 V.

The initial discharge capacity (mAh/g) with respect to the secondary battery according to the Examples and Comparative Examples was measured, and the results were reported in Table 1. Further, the initial efficiency (%) and the charge capacity retention rate, converted to a percentage (%), after a certain cycle relative to the initial charge capacity were measured, and the results were reported in Table 2.

TABLE 1

| | Ex. 1 | Ex. 2 | Ex. 3 | C. Ex. 1 | C. Ex. 2 |
|---|---|---|---|---|---|
| Initial discharge | 520 | 415 | 600 | 488 | 330 |
| capacity, mAh/g | | | | | |

TABLE 2

| | Ex. 1 | Ex. 2 | Ex. 3 | C. Ex. 2 |
|---|---|---|---|---|
| Initial efficiency, % | 80 | 85 | 75 | 89 |
| Charge capacity | 70%@50 | 93%@100 | 85%@30 | 89%@100 |
| retention rate, % | | | | |

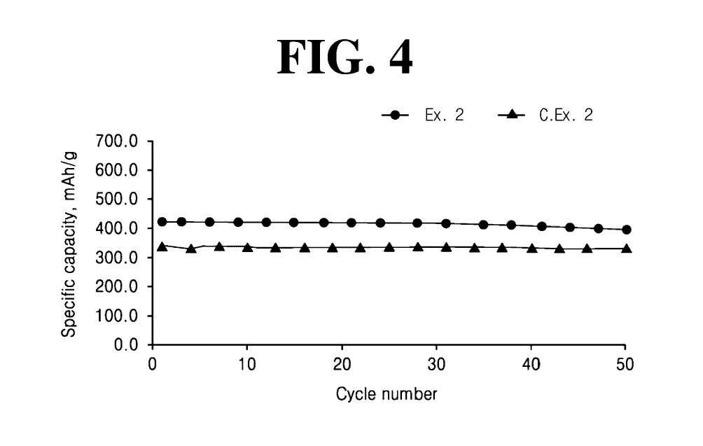

FIG. 4 shows the measurement results for the discharge capacity depending on the cycles with respect to the secondary batteries prepared in Example 2 and Comparative Example 2.

FIG. 4 shows is a graph showing the results of measuring the discharge capacity of the cycle with respect to the secondary batteries manufactured in Example 2 and Comparative 2.

As can be seen from Table 1, the secondary battery manufactured in Examples 1 to 3 employs the silicon-carbon composite in accordance with an embodiment of the present disclosure, which can thus achieve a higher initial discharge capacity, compared to the secondary batteries manufactured by Comparative Example 1 using a carbonized silicon-carbon composite without forming an electrically conductive material and a combined mixture, and by Comparative Example 2 using only graphite.

Further, referring to Table 2 and FIG. 4, it can be seen that the secondary battery prepared in Comparative Example 2 with only graphite has excellent initial efficiency, but the initial discharge capacity and the charge capacity retention rate are low.

On the other hand, in the case of Example 2 which is a secondary battery having 1:3 mixed weight ratio of the silicon-carbon composite according to the disclosure and the graphite, it can be seen that the negative electrode having increased discharge capacity versus graphite and high charge capacity retention rate could be implemented.

Therefore, in the case of Comparative Example 2 using only the graphite in the negative electrode, it is problematic that the initial efficiency is relatively high, but the initial discharge capacity is very low. However, it can be seen that the secondary battery manufactured in Example 2 where carbon black is dispersed as a conductive material within the silicon-carbon composite can provide high initial discharge capacity and at the same time produce at least equivalent level of excellent charge capacity retention rate.

### Experimental Example 2

### Changes in the Discharge Capacity in Accordance with the Content of Electrically Conductive Material

In the silicon-carbon composite in which the nano-Si particulates and the electrically conductive material are distributed within the amorphous carbon, the charge and discharge was tested according to the content of the electrically conductive material contained in the composite, and the results were reported in Table 3.

TABLE 3

Inner carbon black, %

| | 0% | 5% | 15% | 20% |
|---|---|---|---|---|
| Discharge capacity, | 418.3 | 427.5 | 436.3 | 486.3 |
| mAh/g | | | | |
| Si capacity expression | 52 | 57 | 65 | 79 |
| rate, % | | | | |

Experimental Example 2 is for the case of using carbon black as an electrically conductive material. It can be seen that Si capacity expression rate increases with the increase in the content of the carbon black contained in the composite, and thereby the discharge capacity also increases.

Thus, it can be seen that when carbon black is contained within a composite, it allows Si volume expansion to ease and thereby represent a high capacity of silicon characteristics.

While the preferred examples of the invention have been shown and described for illustrative purpose only, it should be understood that various substitutions, modifications and variations may be made by those skilled in the art without departing from the spirit or scope of the invention. Accordingly, all such modifications and variations are included in the scope of the invention as defined by the following claims.

What is claimed is:

1. A composition for preparing a silicon-carbon composite, having a combined mixture, comprising a polymer matrix, and nano-Si particulates and an electrically conductive material dispersed in the polymer matrix, embedded in an amorphous carbon.

2. The composition of claim 1, wherein the polymer matrix is a copolymer of at least one cross-linkable monomer selected from acrylic acid, acrylate, methyl methacrylic acid, methyl methacrylate, acrylamide, vinyl acetate, maleic acid, styrene, acrylonitrile, phenol, ethylene glycol, lauryl methacrylate, and vinyl difluoride.

3. The composition of claim 1, wherein the nano-Si particulates, as indicated by D50 which is defined as a diameter corresponding to 50% cumulative weight in particle size distribution, has a particle size distribution characteristic of 2 nm<D50<120 nm.

4. The composition of claim 3, wherein the nano-Si particulates, as indicated by D90 which is defined as a diameter corresponding to 90% cumulative weight in particle size distribution, has a particle size distribution characteristic of 1<D90/D50<1.4.

5. The composition of claim 1, wherein the electrically conductive material is at least one selected from the group consisting of carbon black, Ketjen black, lamp black, channel black, acetylene black, furnace black, thermal black, graphene, fullerene, carbon nanotube, carbon nanofiber, and combinations thereof.

6. The composition of claim 1, wherein the composition comprises 10 to 40 parts by weight of the nano-Si particulates, 10 to 40 parts by weight of the electrically conductive material, and 20 to 80 parts by weight of the amorphous carbon, relative to 100 parts by weight of the composition.

7. The composition of claim 1, wherein the amorphous carbon is at least one selected from a soft carbon and a hard carbon.

8. A silicon-carbon composite having nano-Si particulates and an electrically conductive material dispersed in an amorphous carbon, wherein, in the cross-section of the composite taken by a scanning electron microscope, when the cross-section of the composite is divided into nine regions having an equal area, the content (% by weight) of the nano-Si particulates within each region is 0.3 to 1.7 times the average value of the content (% by weight) of the nano-Si particulates over the entire region.

9. The silicon-carbon composite of claim 8, wherein the electrically conductive material is at least one selected from the group consisting of carbon black, Ketjen black, lamp black, channel black, acetylene black, furnace black, thermal black, graphene, fullerene, carbon nanotube, carbon nanofiber, and combinations thereof.

10. The silicon-carbon composite of claim 8, wherein the composition comprises 10 to 40 parts by weight of the nano-Si particulates, 10 to 40 parts by weight of the electrically conductive material, and 20 to 80 parts by weight of the amorphous carbon, relative to 100 parts by weight of the composition.

11. The silicon-carbon composite of claim 8, wherein the amorphous carbon is at least one selected from a soft carbon and a hard carbon.

12. A method of producing a silicon-carbon composite, comprising:
(1) forming a slurry of nano-Si particulates;
(2) mixing the slurry of nano-Si particulates and an electrically conductive material;
(3) heating and then grinding the mixture in step (2) to form a combined mixture of the nano-Si particulates and the electrically conductive material;
(4) dissolving an amorphous carbon into a solvent to form a carbonaceous solution; and
(5) adding the combined mixture of the nano-Si particulates and the electrically conductive material in step (3) to the carbonaceous solution in step (4) and then subjecting to a carbonization and pulverization.

13. The method of claim 12, wherein step (2) further comprises adding a cross-linkable monomer, and then subjecting to a polymerization.

14. The method of claim 12, wherein the electrically conductive material is at least one selected from the group consisting of carbon black, ketjen black, lamp black, channel black, acetylene black, furnace black, thermal black, graphene, fullerene, carbon nanotube, carbon nanofiber, and combinations thereof.
